(19) United States
(12) Patent Application Publication
(10) Pub. No.: US 2026/0235725 A1
(43) Pub. Date: Aug. 13, 2026

(54) METHOD AND SYSTEM FOR IDENTIFYING AERIAL VEHICLE

(71) Applicant: Ramot at Tel-Aviv University Ltd., Tel-Aviv (IL)

(72) Inventors: Pavel GINZBURG, Tel-Aviv (IL); Dmytro VOVCHUK, Tel-Aviv (IL)

(73) Assignee: Ramot at Tel-Aviv University Ltd., Tel-Aviv (IL)

(21) Appl. No.: 19/156,459

(22) PCT Filed: Feb. 15, 2024
(86) PCT No.: PCT/IL2024/050182

§ 371 Date: Aug. 14, 2025

(30) Foreign Application Priority Data
Feb. 15, 2023 (IL) 300757

(51) Int. Cl. G01S 7/41; G01S 13/75

(52) U.S. Cl. CPC G01S 7/415; G01S 13/75

(57) ABSTRACT

A method of making an areal vehicle identifiable, comprises attaching to a rotor of the areal vehicle a scattering structure selected to scatter an incoming electromagnetic wave and generate an identifiable micro-Doppler signature during rotation of the rotor.

### RELATED APPLICATIONS

This application claims the benefit of priority of Israeli Patent Application No. 300757 filed on Feb. 15, 2023, the contents of which are incorporated herein by reference in their entirety.

### FIELD AND BACKGROUND OF THE INVENTION

The present invention, in some embodiments thereof, relates to identification of vehicles and, more particularly, but not exclusively, to a method and system for identifying aerial vehicle having a rotor.

The identification of unmanned aerial vehicles, such as drones and copters, operating in a shared airspace can be difficult when many vehicles are visible, particularly when an observer is far from the vehicles. Identification may be useful for managing individual vehicles, tracking regulatory compliance, or efficiently and safely managing shared airspace resources.

### SUMMARY OF THE INVENTION

According to an aspect of some embodiments of the present invention there is provided a method of making an areal vehicle identifiable. The method comprises attaching to a rotor of the areal vehicle a scattering structure selected to scatter an incoming electromagnetic wave and generate an identifiable micro-Doppler signature during rotation of the rotor.

According to some embodiments of the invention the scattering structure is electromagnetically passive.

According to some embodiments of the invention the scattering structure is electromagnetically active and the method comprising powering the scattering structure during the rotation of the rotor.

According to some embodiments of the invention the method further comprising transmitting the electromagnetic wave to the vehicle and analyzing a micro Doppler pattern of a wave scattered off the rotor to identify the vehicle.

According to some embodiments of the invention the analysis comprises applying a machine learning procedure to the pattern.

According to some embodiments of the invention the machine learning procedure is trained to identify the pattern irrespectively of a direction to the vehicle.

According to some embodiments of the invention the scattering structure is specific to the areal vehicle and is unique among a plurality of scattering structures being attached to rotors of other areal vehicles.

According to some embodiments of the invention the areal vehicle is a member of a group of areal vehicles, and wherein the scattering structure is specific to the group.

According to some embodiments of the invention the method comprises providing a set of scattering structures, each being characterized by a different micro Doppler signature, wherein the attached scattering structure is one of the set of scattering structures.

According to some embodiments of the invention there is a group of areal vehicles, and the method comprises, for each areal vehicle of the group, selecting a different scattering structure or a different combination of scattering structures from the set and attaching the scattering structure or combination of scattering structures to a rotor of the areal vehicle of the group.

According to some embodiments of the invention there is a group of areal vehicles, and the method comprises selecting a scattering structure or a combination of scattering structures from the set and attaching the scattering structure or combination of scattering structures to a rotor of each areal vehicle of the group.

According to some embodiments of the invention at least two of the scattering structures in the combination are identical but are attached at different orientations relative to the rotor.

According to some embodiments of the invention at least two of the scattering structures in the combination are of different sizes but are otherwise identical.

According to some embodiments of the invention at least two of the scattering structures in the combination are of different shapes but are otherwise identical.

According to some embodiments of the invention the scattering structure has a length of from about 10 cm to about 10 m.

According to some embodiments of the invention the scattering structure is configured to resonate at a frequency of the electromagnetic wave.

According to some embodiments of the invention the method comprises attaching a plurality of scattering structures overlapping in their resonance frequency, wherein at least two of the scattering structures have a different multipolar resonance.

According to some embodiments of the invention the scattering structure is selected from the group consisting of a split-ring resonator, a dual-split ring resonator, a spiral loop, a closed ring, a cross-shaped resonator, and coupled strips.

According to some embodiments of the invention the method comprises dynamically varying the signature.

According to some embodiments of the invention the dynamically varying is executed electronically.

According to some embodiments of the invention the dynamically varying is executed mechanically.

According to some embodiments of the invention the dynamically varying is executed acoustically.

According to some embodiments of the invention the method comprises electronically disabling the scattering.

According to some embodiments of the invention the rotor has a plurality of blades and the method comprises attaching the scattering structure to at least two of the blades.

According to some embodiments of the invention the rotor has a plurality of blades and the method comprises attaching a different scattering structure to at least two of the blades.

According to an aspect of some embodiments of the present invention there is provided an areal vehicle, comprising: a rotor; and an electromagnetically passive scattering structure attached to the rotor and being selected to scatter an electromagnetic wave and to generate an identifiable micro Doppler signature during rotation of the rotor.

According to some embodiments of the invention the scattering structure is configured to resonate at a frequency of the electromagnetic wave.

According to some embodiments of the invention the electromagnetic wave has a frequency of from about 300 MHz to about 300 GHZ.

According to some embodiments of the invention the scattering structure has a length of from about 10 cm to about 10 m.

According to an aspect of some embodiments of the present invention there is provided an areal fleet, comprising a group of areal vehicles, each comprising a rotor and an electromagnetically passive scattering structure attached to the rotor, the scattering structure being selected to scatter an electromagnetic wave and to generate an identifiable micro Doppler signature during rotation of the rotor.

According to some embodiments of the invention a scattering structure of each areal vehicle is specific to the areal vehicle and is unique among the group.

According to some embodiments of the invention all areal vehicles of the group have scattering structures characterized by substantially identical signatures.

According to some embodiments of the invention the electromagnetic wave has a frequency of from about 300 MHz to about 300 GHz.

According to some embodiments of the invention the electromagnetic wave is a continuous wave.

According to some embodiments of the invention the electromagnetic wave is a pulsed wave.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart diagram of a method of making an areal vehicle identifiable, according to some embodiments of the present invention;

FIG. 2 is a schematic illustration of an areal vehicle, according to some embodiments of the present invention;

FIG. 3 is a schematic illustration of a side view of a scattering structure in embodiments of the invention in which scattering structure has a pattered surface;

FIG. 4 is a schematic illustration of a top view of a scattering structure in embodiments of the invention in which the scattering structure is a metamaterial or metasurface having a plurality of resonators;

FIG. 5 is a schematic illustration of a plurality of areal vehicles including an identifiable group of areal vehicles, according to some embodiments of the present invention;

FIG. 6 is a schematic illustration of a radar system which transmits a wave to detect an areal vehicle including a scattering structure attached to a rotor thereof, according to some embodiments of the present invention;

FIG. 7 shows a micro-Doppler comb obtained in experiments performed according to some embodiments of the present invention demonstrating a difference between untagged and differently tagged objects;

FIGS. 8A-F are schematic illustrations pf several types of resonators, according to some embodiments of the present invention; and

FIGS. 9A-C are schematic illustration of three micro Doppler signatures, corresponding, according to some embodiments of the present invention to three individual vehicles of a group of vehicles.

### DESCRIPTION OF SPECIFIC EMBODIMENTS OF THE INVENTION

The present invention, in some embodiments thereof, relates to identification of vehicles and, more particularly, but not exclusively, to a method and system for identifying aerial vehicle having a rotor.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

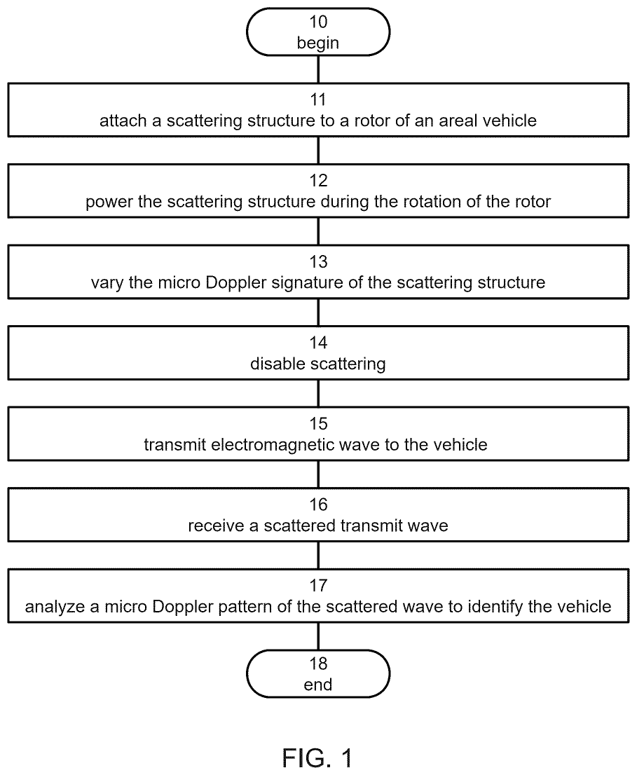

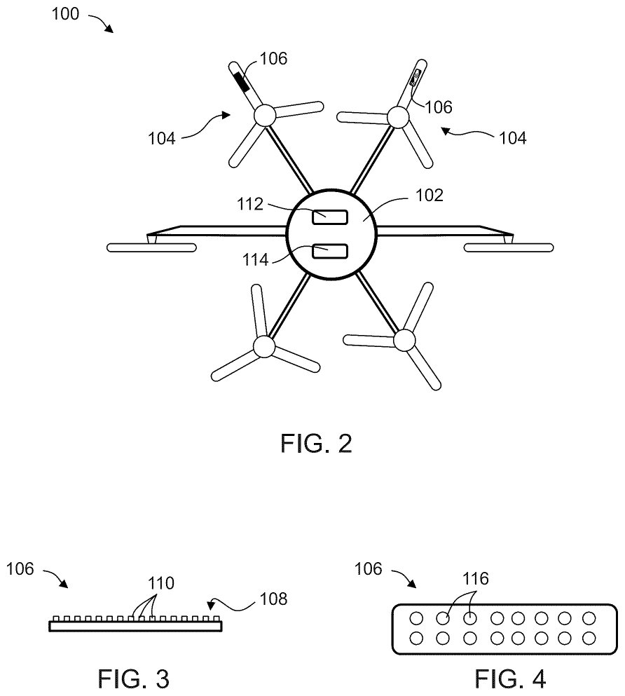

FIG. 1 is a flowchart diagram of a method of making an areal vehicle identifiable, and FIG. 2 is a schematic illustration of an areal vehicle 100, according to some embodiments of the present invention. It is to be understood that, unless otherwise defined, the operations described hereinbelow can be executed either contemporaneously or sequentially in many combinations or orders of execution. Specifically, the ordering of the flowchart diagrams is not to be considered as limiting. For example, two or more operations, appearing in the following description or in the flowchart diagrams in a particular order, can be executed in a different order (e.g., a reverse order) or substantially contemporaneously. Additionally, several operations described below are optional and may not be executed.

The method begins at 10 and continues to 11 at which a scattering structure 106 is attached to a rotor 104 of areal vehicle 100. Vehicle 100 can be of any type that includes a rotor. Representative examples of aerial vehicles suitable for the present embodiments include, without limitation, a drone, a min-drone, a rotary wing aircraft (e.g., a helicopter, an autogyro), and a propeller-driven fixed wing aircraft.

Scattering structure can be provided as a sticker or in any other form that is attachable to rotor 104. Typically, scattering structure 106 is attached to the blade of rotor 104. Preferably, scattering structure 106 is lightweight and sufficiently thin relative to the weight and thickness of rotor 104 so as not to interfere with its function. Typically, the mass of scattering structure 106 is less than 1% or less than 0.1% of the mass of rotor 104 and the thickness of scattering structure 106 is less than 1% or less than 0.1% of the thickness of rotor 104. The length of scattering structure 106 can be from about 10 cm to about 10 m, but preferably less than the length of the blade of rotor 104.

Scattering structure 106 is selected to scatter an incoming electromagnetic wave and generate an identifiable micro-Doppler signature during the rotation of rotor 104.

As used herein “micro-Doppler” refers to the Doppler frequency modulation caused by the motion of small objects relative to a larger moving object (e.g., the motion of rotor 104 relative to the motion of the body 102 of vehicle 100 during its flight).

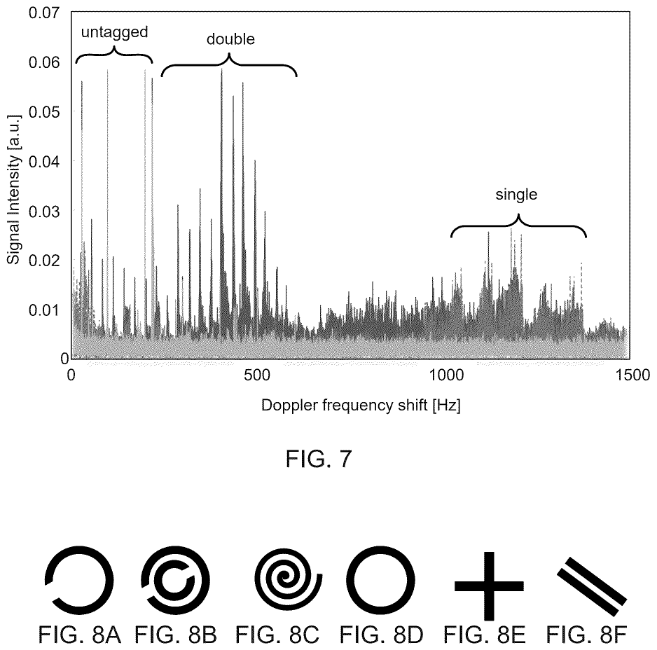

As used herein “micro-Doppler signature” refers to a pattern that describes the frequency modulation of a signal as a result of the motion of the smaller object (e.g., rotor 104). Such a pattern can be provided as a so called “micro-Doppler comb,” which a graph in the frequency-intensity plane. For example, the abscissa of the graph can represent the Doppler shift (the difference between the frequency of a wave transmitted to the smaller object and the frequency of a wave scattered off the smaller object), and the ordinate of the graph can represent the intensity of the signal. A representative micro-Doppler signature when provided as a micro-Doppler comb is shown in FIG. 7 of the Examples section that follows. The pattern can also be provided in digital form, e.g., as a set of N pairs (Δfᵢ, Iᵢ) of values where Δfᵢ, i=1, 2, . . . , N, represent Doppler shifts and Iᵢ represent corresponding signal intensities. Other ways for describes the frequency modulation of the signal are also contemplated. For example, it is appreciated that when two signals that arrive from rotors having the same size and rotating at the same speed are different in terms of their intensity as a function of the Doppler shift, they can also be different in terms of their Doppler shift as a function of the time. Thus, the pattern that describes the frequency modulation can equivalently be a graph or a set of pairs of values that describe Doppler shift as a function of the time.

Operation 11 can be repeated one or more times, so as to attach more than one scattering structure 106 to one or more rotors of vehicle 100. Two or more scattering structures 106 can be attached to the same blade, or to different blades of the same rotor, or different rotors, as desired. In the schematic illustration shown in FIG. 2, there are two scattering structures 106, each attached to a blade of a different rotor of vehicle 100.

In some embodiments of the present invention scattering structure 106 is specific to vehicle 100 and is unique among a plurality of scattering structures being attached to rotors of other areal vehicles. This is advantageous since it allows identifying vehicle 100 among other vehicles operating in the same region.

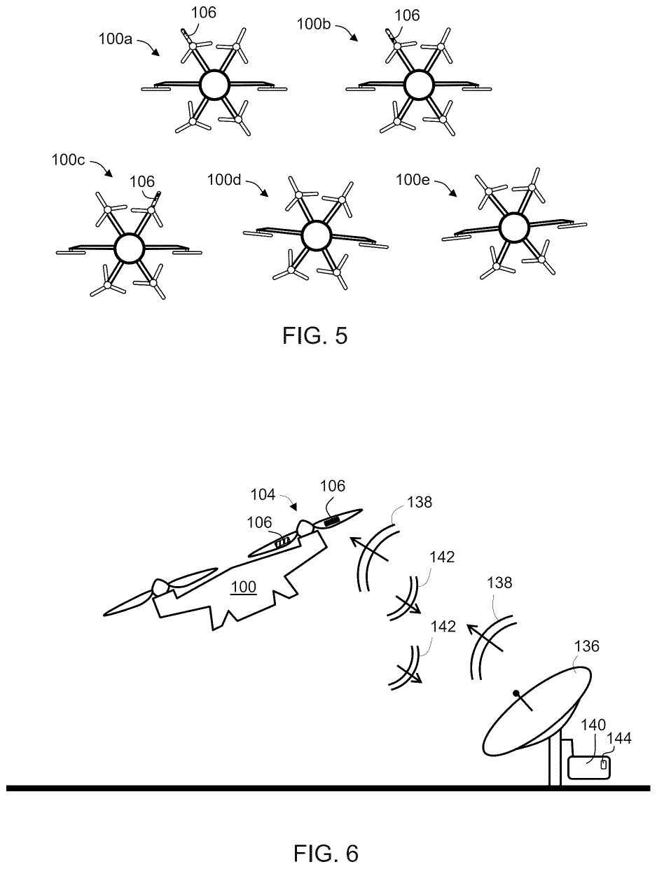

Scattering structure 106 can also be used for identifying a group of areal vehicles. This will be explained with reference to FIG. 5, showing a plurality of areal vehicles 100a, 100b, . . . , 100e. Suppose that vehicles 100a, 100b, and 100c belong to a group to be identified (e.g., “friendly vehicles”), while vehicles 100e, and 100f are not members of this group (“foe vehicles”). According to some embodiments of the present invention structure 106 is attached to a rotor of each member 100a, 100b, 100c, of the group, wherein each of these structures is selected to have a micro Doppler signature that is specific to the group. Since only the members of the group have scattering structure 106 that has the specific micro Doppler signature, they can be distinguished from the other vehicles, particularly foe vehicles 106e and 106f.

In some embodiments of the present invention the scattering structure that is attached to vehicle is selected from a set of scattering structures, each being characterized by a different micro Doppler signature. One or more other scattering structures of the set can be attached to one or more rotors of other vehicles within a group of areal vehicles, in a manner that for each areal vehicle of the group, a different scattering structure or a different combination of scattering structures is selected from the set. For example, with reference to FIG. 5, the scattering structures attached to the rotors of vehicles 100a, 100b, 100c, can each have a different micro Doppler signature. This allows the identification of each individual vehicle of the group.

In some embodiments of the present invention scattering structure 106 is electromagnetically passive.

As used herein, “electromagnetically passive scattering structure” refers to a structure that is incapable of emitting non-thermal electromagnetic radiation on its own, wherein any non-thermal electromagnetic radiation received from the structure is reflected or scattered off its surface.

The scattering structure is optionally and preferably made of a conductive material, providing contrast to an incoming electromagnetic wave. The micro-Doppler signature of the scattering structure can be set by selecting the material, size, and/or geometrical shape. In some embodiments of the present invention the surface of scattering structure is patterned, and the pattern can alternatively or additionally be selected to provide an identifiable micro-Doppler signature. FIG. 3 is a side view of scattering structure 106 in embodiments in which its surface is pattered. The pattern 108 can be made by any technology known in the art, such as, but not limited to, three-dimensional printing, lithography, laser ablation, vapor deposition, and the like. In some embodiments of the present invention pattern 108 comprises an arrangement of nanostructures 110.

Also contemplated, are embodiments in which scattering structure 106 is a metamaterial or metasurface. FIG. 4 is a top view of scattering structure 106 in embodiments in which structure 106 is a metamaterial or metasurface having a plurality of resonators 116, optionally and preferably arranged as an array. Representative examples of types of resonators suitable for the present embodiments include, without limitation, split-ring resonators, dual-split ring resonators, spiral loops, closed rings, cross-shaped resonators, and coupled strips. Schematic illustrations of such types of resonators are provided in FIGS. 8A-F, and described below.

A split-ring resonator (FIG. 8A) is a symmetrically split ring made from a conducting material, where the split in the ring creates a gap. The specific dimensions and geometry of the split ring, including the size of the ring, and the dimensions of the gap, determine its resonant frequency.

A dual-split ring resonator (FIG. 8B) consists of two split ring resonators arranged in proximity to each other, typically one inside the other. The split ring structures may be oriented in a symmetric or asymmetric manner. The specific dimensions and geometry of the dual-split ring resonator as well as the separation between the rings, determine its resonant frequencies.

A spiral loop resonator (FIG. 8C) is a type of conductive resonant structure having a spiral or helical geometry, which imparts specific resonant properties. The spiral or helical shape introduces inductance and capacitance, leading to resonance when interacting with an electromagnetic wave of specific central frequency.

A closed ring resonator (FIG. 8D) is a type of resonant structure which consists of a closed loop or ring-shaped conductor. It exhibit resonant behavior at specific frequencies. The conductor forms a continuous loop, and the size of the loop determines the resonant frequency.

A cross-shaped resonator (FIG. 8E) is a type of resonant structure having a cruciform geometry. A cross-shaped resonator exhibits resonance at a specific frequency determined by the size of the cruciform, the angle between the arms, and the lengths of the arms.

A coupled strips resonator (FIG. 8F) is a type of resonant structure having two or more stripes of conductive material having a gap therebetween. The stripes need not be straight or parallel to each other. A coupled strips resonator exhibits resonance at a specific frequency determined by the size and shape of the stripes, and the gap between them.

In some embodiments of the present invention scattering structure 106 has a single resonator of any of the aforementioned types, rather than a plurality of resonators. In some embodiments of the present invention scattering structure 106 is configured to resonate at a frequency of the electromagnetic wave expected to be used for its identification. For example, when scattering structure 106 has a single resonator or a plurality of resonators, the resonance frequency of the resonator is approximately the same as the central frequency of the electromagnetic wave expected to be used for its identification. In some embodiments of the present invention a plurality of scattering structures are attached to one or more of the rotors of the vehicle, wherein the scattering structures are overlapping in their resonance frequencies, and wherein at least two of the scattering structures have a different multipolar resonance.

In some embodiments of the present invention scattering structure 106 is a superscatterer, having a scattering cross section of more than the physical cross section of scattering structure 106, or more than λ², where λ is the wavelength of the wave scattered by structure 106.

In any of the embodiments described herein the scattering cross section of vehicle 100 is higher when scattering structure 106 is attached to rotor 104, than when no scattering structure is attached to vehicle 100.

In some embodiments of the present invention scattering structure 106 has non-isotropic micro-Doppler signature, so that the relative orientation between scattering structure 106 and rotor 104 can be used as a degree of freedom to combinatorically increase the number of possible signatures from which the signature of a particular vehicle or group of vehicles can be selected. Thus, for example, a combination of two or more scattering structures can be attached to one or more of rotors of a particular vehicle, wherein at least two of the scattering structures in the combination are identical but are attached at different orientations relative to the rotor, or are of different sizes but are otherwise identical, or are of different shapes but are otherwise identical.

In some embodiments of the present invention scattering structure 106 is electromagnetically active. In these embodiments, scattering structure is, or comprise, an active metamaterial or metasurface that varies the scattering properties of scattering structure 106, responsively to a voltage applied thereto. For example, such a metamaterial or metasurface can be a cellular structure having controllable response to electromagnetic radiation interacting therewith. When structure 106 is electromagnetically active, vehicle 100 preferably comprises a controller 112 and a power source 114 for controlling the scattering properties of structure 106. In these embodiments, the method proceeds to 12 at which structure 106 is powered (e.g., by means of controller 112) during the rotation of rotor 104. In some embodiments of the present invention the method proceeds to 13 at which the micro-Doppler signature of structure 106 is dynamically varied. This is optionally and preferably be done by means of a controller, such as, but not limited to, controller 112. The controller can vary the micro-Doppler signature of structure 106 by changing its scattering properties. This can be done electronically (for example, by varying the voltage applied to the electromagnetically active structure), mechanically (for example, by changing the orientation of structure 106), or acoustically (e.g., by generating acoustic vibrations in structure 106).

When structure 106 is electromagnetically active, the method optionally and preferably proceeds to 14 at which the scattering by surface 106 is electronically disabled. For example, when structure 106 is a controllable metamaterial or metasurface, the resonance frequency of the metamaterial or metasurface can be varied by controller 112 to a resonance frequency that is sufficiently different from the central frequency of the electromagnetic wave that is transmitted to the vehicle from a radar, thereby substantially suppressing its scattering cross-section to that wave.

In some embodiments of the present invention the method continues to 15 at which an electromagnetic wave is transmitted to vehicle 100. The transmission at 15 is typically by means a radar configured to transmit and receive electromagnetic waves. FIG. 6 schematically illustrates a radar system 136 which transmits a wave 138. A portion of wave 138 incidents on areal vehicle 100, including scattering structure 106 attached to rotor 104 thereof. In the schematic illustration shown in FIG. 6, two different scattering structures 106 are attached to two different blades of the same rotor 104, but as indicated above, there can alternatively be a single scattering structure 106 on vehicle 100, or two or more scattering structures can be attached to different blades of the same or different rotors. A backscattered wave from vehicle 100 is shown at 142.

The frequency of the electromagnetic wave 142 is preferably selected to allow the wave 142 to interact with scattering structure 106 and be scattered thereby. In some embodiments of the present invention the frequency of the electromagnetic wave matches the resonance frequency of scattering structure 106.

Typically, the frequency of the electromagnetic wave 142 is within the range defined from about 300 MHz to about 300 GHz. The electromagnetic wave 142 can be a continuous wave or a pulsed wave, as desired.

The method preferably proceeds to 16 at which a wave scattered off rotor 104 is received. Operation 16 can be executed by the same radar system 136. Radar 136 receives the backscattered wave 142, and converts it to an electrical signal as known in the art. Radar 136 can optionally and preferably be supplemented with a data processor 140 having a circuit which analyzes the frequency contents of the signal (e.g., by applying a Fourier transform or by any other known technique), to provide a micro Doppler pattern characterizing wave 142.

In some embodiments of the present invention the method proceeds to 17 at which the micro Doppler pattern of the received wave 142 is analyzed so as to identify the vehicle.

The analysis can be by any known technology for analyzing signals. In some embodiments of the present invention the analysis employ a lookup table or library of micro Doppler signatures of identified scattering structures. In these embodiments, the analysis includes comparing the pattern characterizing wave 142 to entries of the lookup table or library, and identifying the vehicle based on the entry of the lookup table or library that best matches the pattern characterizing wave 142.

In some embodiments of the present invention the analysis comprises applying a machine learning procedure to the pattern characterizing wave 142.

As used herein, the term “machine learning” refers to a procedure embodied as a computer program configured to induce patterns, regularities, or rules from previously collected data to develop an appropriate response to future data, or describe the data in some meaningful way.

Representative examples of machine learning procedures suitable for the present embodiments, include, without limitation, clustering, association rule algorithms, feature evaluation algorithms, subset selection algorithms, support vector machines, classification rules, cost-sensitive classifiers, vote algorithms, stacking algorithms, Bayesian networks, decision trees, neural networks (e.g., fully-connected neural network, convolutional neural network), instance-based algorithms, linear modeling algorithms, k-nearest neighbors (KNN) analysis, ensemble learning algorithms, probabilistic models, graphical models, logistic regression methods (including multinomial logistic regression methods), gradient ascent methods, singular value decomposition methods and principle component analysis.

Preferably, the machine learning procedure comprises an artificial neural network.

Artificial neural networks are a class of algorithms based on a concept of inter-connected “neurons.” In a typical neural network, neurons contain data values, each of which affects the value of a connected neuron according to connections with pre-defined strengths, and whether the sum of connections to each particular neuron meets a pre-defined threshold. By determining proper connection strengths and threshold values (a process also referred to as training), a neural network can decode the range information from the input information (for example, the image data itself or some transform, e.g., a complex cepstrum transform, thereof). Oftentimes, these neurons are grouped into layers in order to make connections between groups more obvious and to each computation of values. Each layer of the network may have differing numbers of neurons, and these may or may not be related to particular qualities of the input data.

In one implementation, called a fully-connected neural network, each of the neurons in a particular layer is connected to and provides input value to those in the next layer. These input values are then summed and this sum compared to a bias, or threshold. If the value exceeds the threshold for a particular neuron, that neuron then holds a positive value which can be used as input to neurons in the next layer of neurons. This computation continues through the various layers of the neural network, until it reaches a final layer. At this point, the output of the neural network procedure can be read from the values in the final layer. Unlike fully-connected neural networks, convolutional neural networks operate by associating an array of values with each neuron, rather than a single value. The transformation of a neuron value for the subsequent layer is generalized from multiplication to convolution. In various exemplary embodiments of the invention the machine learning procedure is a convolutional neural network (CNN).

The machine learning procedure used according to some embodiments of the present invention is a trained machine learning procedure, which provides output that is related non-linearly to the information with which it is fed.

A machine learning procedure can be trained according to some embodiments of the present invention by feeding a machine learning training program with training data including micro Doppler patterns and associated identifications of scattering structures that produced these patterns. Once the data are fed, the machine learning training program generates a trained machine learning procedure which can then be used without the need to re-train it. The trained machine learning procedure can then be stored in a computer-readable memory 144 of data processor 140. Preferably, the machine learning training program trains the procedure to identify the pattern irrespectively of a direction to the vehicle. This can be done by feeing the machine learning training program with training data that includes multiple micro Doppler patterns that are produced at different directions relative to the same scattering structure.

The method ends at 18.

According to some embodiments of the present invention there is provided an areal fleet, comprising a group of areal vehicles, each comprising a rotor and an electromagnetically passive scattering structure attached to the rotor, wherein the scattering structure is selected to scatter an electromagnetic wave and to generate an identifiable micro Doppler signature during rotation of said rotor. A representative example of such an areal fleet, according to some embodiments of the present invention, includes the group of vehicles 100a, 100b, and 100c illustrated in FIG. 5.

The scattering structure of each areal vehicle of the fleet can be specific to the respective areal vehicle and is unique among the group. Thus, in these embodiments, each of vehicles 100a, 100b, and 100c includes a scattering structure or a combination of scattering structures that provides a unique micro Doppler signature, and can be distinguished from the micro Doppler signatures of any other vehicle other within the group. Alternatively, all areal vehicles of the group can have scattering structures characterized by substantially identical signatures. This allows identifying the fleet, but not individual vehicles within the fleet.

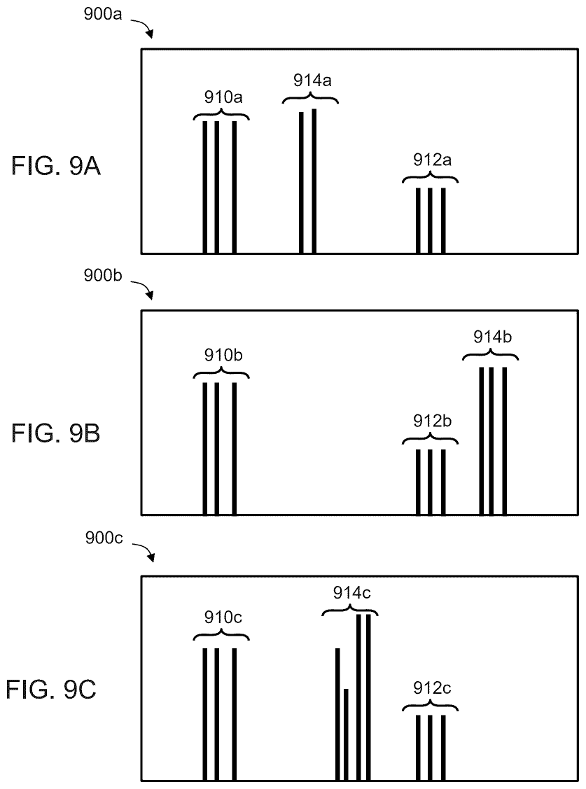

Also contemplated, are embodiments in which the scattering structure of each areal vehicle of the fleet is specific to the respective areal vehicle, is unique among the group, but has a micro Doppler signature that is also specific to the group. For example, the micro Doppler signature of each vehicles in the group can include a signatures portion that is the same among all vehicles in the group and also a portion that is unique within the group. A representative example of this embodiment is illustrated in FIGS. 9A-C. Shown are micro Doppler signatures 900a, 900b and 900c, corresponding to three individual vehicles of a group of vehicles (e.g., vehicles 100a, 100b, 100c, respectively). In the representative illustration of FIGS. 9A-C, which is not to be considered, the signatures are provided as micro Doppler combs. Parts 910a and 912a of signature 900a, are respectively similar to parts 910b and 912b of signature 900b, and also to parts 910c and 912c of signature 900c, indicating that vehicles 100a, 100b, and 100c are members of the same group. On the other hand, each of the three signature also has a signature that is unique among the group (see part 914a of signature 900a, part 914b of signature 900b, and part 914c of signature 900c), allowing to distinguish between vehicles that are members of the same group.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Small airborne targets, e.g., drones or copters, possess a significant problem for radar-based surveillance systems owing to their relatively small radar scattering cross-sections (e.g., less than 0.5 m², or less than 0.1 m², or less 0.02 m², e.g., 0.01 m² or less). The present embodiments provide a technique that allows reliable identification of those targets with passive embedded labels. Efficient passive reflectors with significant radar signatures, designed with the aid of conventional technologies, are not a suitable solution for small drones owing to form factor and weight restrictions.

The present embodiments provide an efficient passive add-on system, which can be uniquely identified by a radar, such as, but not limited to, an X-band radar, from a distance. According to some embodiments of the present invention scattering structures are attached to the rotor blades of an aerial vehicle, generating object-specific micro-Doppler signatures that are identifiable by receiving the micro-Doppler signal using a radar and a signal processor configured to analyze the micro-Doppler signal and identify the signature. The signature is typically in the form of a series of peaks each at a different Doppler frequency where the frequencies of the peaks and their heights collectively form the specific signature of the scattering structure on the rotating rotor.

The aerial vehicle is preferably a small size vehicle such as, but not limited to, a drone or a microcopter. The largest dimension of the aerial vehicle is preferably less than 20 wavelengths of the radiation emitted by the detecting radar, making its electromagnetic cross-section too small to be detected by non-Doppler radars.

The advantage of the technique of the present embodiments is that it benefits from the high-time varying scattering cross-section, generating an object-specific micro-Doppler signature. The technique of the present embodiments allows detecting small aerial vehicles from a distance of at least 1 or at lest 2 or at least 4 or at least 8 kilometers, e.g., 10 km or more.

Conventional friend or foe identification strategies employ transponders, providing coded 2-way communication channels. The inventors found several disadvantages in this approach. Firstly, any transmitting system can be spotted by a third party, and, as the result, the object discloses itself. Secondly, these systems are less reliable, as they are active and require energy and maintenance. Furthermore, these systems can become subject to an electronic warfare attack, such as by active interception, as a transponder has a receive antenna and interfacing electronics. In the case of civil use, the transponder can be disabled with a software-based intervention in the system. This can be done on purpose to avoid regulated no-flight zones, etc.

The advantage of the technique of the present embodiments is that it is based in passive scattering, whereby the micro-Doppler signature can be used as a security identification code, which is changed each time the scattering structure on the rotor is replaced. Such a technique cannot be jammed or spotted by third parties.

The present embodiments are also suitable for use with a fleet of aerial vehicles, e.g., a fleet of drones. In this case, each aerial vehicle is equipped with one or more scattering structures attached to its rotor, serving as a label of the individual aerial vehicle, or a label of the entire fleet. The latter embodiments is particularly useful in a friend or foe identification scenario

The technique of the present embodiments increases the radar visibility of small drones and optionally and preferably grants them a unique identification code. In some embodiments of the present invention the technique serves as an electromagnetic license plate for the vehicle, whereby each vehicle is associated with a unique micro-Doppler signature of the scattering structure or combination of scattering structures that are attached to its rotor. This is useful in civil traffic regulation.

### Experimental

Several resonant stickers have been developed and characterized. The resonant frequency was designed to be 9.1 GHz, complying with the investigating radar characteristics. The stickers were attached to drone blades.

FIG. 7 shows a micro-Doppler signal from 3 different configurations. The signal from a reference untagged drone is shown designated “untagged”, the signal from a drone tagged with a single sticker is designated “single”, and the signal from a drone tagged with two different stickers (on different blades) is designated “double”. A clear difference in the micro-Doppler comb can be identified. FIG. 7 demonstrates the results for an ideal CW radar with a very high Doppler resolution. Pulsed radar trades Doppler and range resolutions. As a result, it has 5 Hz resolution, which is still sufficient to recover the pronounced differences.

The micro-Doppler spectra depends on the scatter's geometry and, specifically on the far-field contribution of resonant multipole and an overlap with the incident field.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method of making an areal vehicle identifiable, comprising attaching to a rotor of the areal vehicle a combination of scattering structures selected to scatter an incoming electromagnetic wave and generate an identifiable micro-Doppler signature of said combination of scattering structures during rotation of said rotor.

2. The method of claim 1, wherein said scattering structure is electromagnetically passive.

3. The method of claim 1, wherein said scattering structure is electromagnetically active and the method comprising powering said scattering structure during said rotation of said rotor.

4. The method of claim 1, further comprising transmitting said electromagnetic wave to the vehicle and analyzing a micro Doppler pattern of a wave scattered off said rotor to identify the vehicle.

5-6. (canceled)

7. The method according to claim 1, wherein said combination of scattering structures is specific to the areal vehicle and is unique among a plurality of scattering structures being attached to rotors of other areal vehicles.

8-9. (canceled)

10. The method according to claim 1, wherein the areal vehicle is a member of a group of areal vehicles, and wherein said combination of scattering structures is specific to said group.

11-12. (canceled)

13. The method according to claim 1, wherein there is a group of areal vehicles, and the method comprises, for each areal vehicle of said group, selecting a different combination of scattering structures from said set and attaching said combination of scattering structures to a rotor of said areal vehicle of said group.

14. (canceled)

15. The method according to claim 1, wherein there is a group of areal vehicles, and the method comprises selecting a combination of scattering structures from said set and attaching said combination of scattering structures to a rotor of each areal vehicle of said group.

16. (canceled)

17. The method according to claim 13, wherein at least two of said scattering structures in said combination are identical but are attached at different orientations relative to the rotor.

18. (canceled)

19. The method according to claim 13, wherein at least two of said scattering structures in said combination are of different sizes but are otherwise identical.

20. (canceled)

21. The method according to claim 13, wherein at least two of said scattering structures in said combination are of different shapes but are otherwise identical.

22-24. (canceled)

25. The method according to claim 1, wherein at least one of said scattering structures is configured to resonate at a frequency of said electromagnetic wave.

26. (canceled)

27. The method according to claim 25, wherein said scattering structures are overlapping in their resonance frequency, wherein at least two of said scattering structures have a different multipolar resonance.

28. (canceled)

29. The method according to claim 25, wherein at least one of said scattering structures is selected from the group consisting of a split-ring resonator, a dual-split ring resonator, a spiral loop, a closed ring, a cross-shaped resonator, and coupled strips.

30. (canceled)

31. The method according to claim 1, comprising dynamically varying said signature.

32. (canceled)

33. The method according to claim 31, wherein said dynamically varying is executed electronically, mechanically or acoustically.

34-38. (canceled)

39. The method according to claim 1, further comprising electronically disabling said scattering.

40. (canceled)

41. The method according to claim 1, wherein said rotor has a plurality of blades and the method comprises attaching a scattering structure of said combination to at least two of said blades.

42-44. (canceled)

45. An areal vehicle, comprising:
a rotor; and
a combination of electromagnetically passive scattering structures attached to said rotor and being selected to scatter an electromagnetic wave and to generate an identifiable micro Doppler signature of said combination of electromagnetically passive scattering structures during rotation of said rotor.

46-48. (canceled)

49. An areal fleet, comprising a group of areal vehicles, each comprising a rotor and a combination of electromagnetically passive scattering structures attached to said rotor, said scattering structures being selected to scatter an electromagnetic wave and to generate an identifiable micro Doppler signature of said combination of electromagnetically passive scattering structures during rotation of said rotor.

50-54. (canceled)
